(19) United States
(12) Patent Application Publication
(10) Pub. No.: US 2017/0176782 A1
(43) Pub. Date: Jun. 22, 2017

(54) BROADBAND THREE-PORT OPTICAL CIRCULATOR WITH INTRODUCED TRIANGULAR-GUIDE COLUMN

(71) Applicant: SHENZHEN UNIVERSITY, Shenzhen (CN)

(72) Inventors: Zhengbiao Ouyang, Shenzhen (CN); Qiong Wang, Shenzhen (CN)

(73) Assignee: SHENZHEN UNIVERSITY

(21) Appl. No.: 15/446,066

(22) Filed: Mar. 1, 2017

Related U.S. Application Data
(63) Continuation of application No. PCT/CN2015/090885, filed on Sep. 28, 2015.

(30) Foreign Application Priority Data
Sep. 29, 2014 (CN) 201410515363.9

(51) Int. Cl. G02F 1/095; G02B 6/122; G02B 6/125

(52) U.S. Cl. CPC G02F 1/0955; G02B 6/125; G02B 6/1225; G02F 2202/32

(57) ABSTRACT

A broadband three-port optical circulator having introduced therein a triangular guide column, comprising two-dimensional triangular lattice photonic crystals constituted by first medium material columns in a low refractive index background medium and three corresponding ports provided with three photonic crystal branch waveguide and distributed at the periphery of the photonic crystals. One second medium material column is arranged at the center at where the three photonic crystal branch waveguide converge, three identical magneto-optical material columns respectively are arranged around the second medium material column, the three magneto-optical material columns are in a rotationally symmetrical distribution at 120° around the center at where the three branch waveguide intersect, and each of the magneto-optical material columns is arranged on the axis of the branch waveguide at where each is located. An electromagnetic signal is inputted from any one port and is outputted from the adjacent port adjacent thereto, while the other port is in an isolated state, thus allowing unidirectional optical circulator transmission. The optical circulator is structurally compact and easy to assemble.

### CROSS-REFERENCE TO RELATED APPLICATIONS

This application is a continuation of International Patent Application No. PCT/CN2015/090885 with a filing date of Sep. 28, 2015, designating the United States, now pending, and further claims priority to Chinese Patent. Application No. 201410515363.9 with a filing date of Sep. 29, 2014. The content of the aforementioned application, including any intervening amendments thereto, are incorporated herein by reference.

### TECHNICAL FIELD

The present invention belongs to the technical field of micro circulators, and in particular relates to a three-port photonic crystal magneto-optical circulator with an introduced guiding triangular column for guiding coupling among a plurality of magneto-optical material columns.

### BACKGROUND OF THE PRESENT INVENTION

With the development of science, technology and economy, large-scale optical integrated-circuit systems have attracted wide attention and research. In an optical circuit, the increasing integration level may remarkably increase the signal interference among elements; and in the case of serious interference, the optical circuit even cannot complete a normal logic function.

In miniaturization and integration of optical devices, photonic crystals (PhCs) have obvious advantages. A PhC is a micro-structure material in which the dielectric constant or magnetic permeability is periodically or quasi-periodically distributed in space, which can forbidden electromagnetic waves in certain frequency bands to propagate therein, thereby forming photonic bandgaps. By utilizing the band-gap effect, photons can be controlled by introducing defects into the PhC, just as the control over electrons in a semiconductor material. The PhC device has many characteristics which cannot be matched by conventional optical devices, such as flexibility in design, small size, excellent performance, and easiness in integration. In recent years, the introduction of magneto-optical materials into PhC structures for implementing various micro magneto-optical circulators has an important application value in the aspects of function enrichment, performance optimization, structural expansion and the like of circulators.

For several types of current three-port PhC magneto-optical circulators, only a single magneto-optical cavity or a single magneto-optical material column is generally used to realize the nonreciprocal deflection in the propagation direction of electromagnetic waves, based either on an air-substrate dielectric-column structure or on a dielectric-substrate air-column structure, and the single magneto-optical cavity or the single magneto-optical material column has certain limitations in operating performances. Therefore, further improvement and expansion should be made in structural types, functional applications, and the like in the three-port circulators, and in particular in broadband PhC magneto-optical circulators with high isolation and low insertion loss.

### SUMMARY OF PRESENT INVENTION

The present invention aims at overcoming the defects in the prior art to provide a broadband three-port optical circulator with a compact structure, easiness in integration, and high isolation so as to realize the unidirectional optical circular transmission of a signal among three ports in a device and obtain excellent performance.

The objectives of the present invention are realized through technical solutions below.

The broadband three-port optical circulator with an introduced guiding triangular column according to the present invention includes a PhC formed by an array of a first dielectric column in a background dielectric with low refractive index, wherein said PhC is a two-dimensional triangular-lattice PhC, and each first dielectric column is set at one lattice point in the triangular lattice; said broadband three-port optical circulator further includes three-branch PhC waveguide which has three ports at the outer ends of the three branches, and the three ports are respectively distributed on the peripheral end surface of the PhC; a second dielectric column is arranged at the intersection center of the three branches of said PhC waveguide; three identical magneto-optical material columns A, B and C are respectively arranged at the periphery of the second dielectric column, said A, B and C are rotationally symmetrically distributed around the intersection center of the three branches of said PhC waveguide at an angle of 120°, each magneto-optical material column is placed on the central axis of the corresponding waveguide branch; an electromagnetic wave signal is input from one of said three ports and output from a next port adjacent thereto, and the other port is in an isolated state so as to perform the unidirectional optical circular transmission; and the main body of said circulator is a two-dimensional V-shaped PhC waveguide in the background dielectric with low refractive index; and the Y-shaped PhC waveguide is formed in the two-dimensional triangular-lattice photonic crystal formed by an array of said first dielectric column.

The background dielectric with low refractive index is a dielectric with refractive indexless than 1.5,

Said background dielectric with low refractive index is air, vacuum, silicon dioxide, or magnesium fluoride.

The first dielectric column is a dielectric with refractive index greater than 2.

Said first dielectric column is silicon, gallium arsenide, titanium dioxide, or gallium nitride.

The cross section of said first dielectric column is regular polygonal.

The cross section of said first dielectric column is regular triangular.

The cross section of said first dielectric column is circular.

The three-branch PhC waveguide is Y-shaped PhC waveguide.

Said three-branch PhC waveguide is formed by removing a group of first dielectric columns in said PhC respectively along a horizontal negative direction, a direction in an angle of −60° with respect to the horizontal direction and a direction in an angle of 60° with respect to the horizontal direction; the PhC at the region between 60° and 180° is integrally translated outwards for a distance b along the 120° axis, the PhC disposed at the region between 180° and 300° is integrally translated outwards for a distance b along the 240° axis, and the PhC at the region between −60° and 60° is integrally translated outwards for a distance b along the 0° axis; the three branches of said PhC waveguide are intersected and rotationally symmetrically distributed at an angle of 120°, and b=\sqrt{3}a/3.

The length of the three-branch PhC waveguide is na, the width is (\sqrt{3}+1)a, a is the lattice constant of the PhC, and n is an integer not smaller than 4.

The second dielectric column is a guiding column in said PhC waveguide, and the connection lines between the center of said second dielectric column and the centers of said three ports are respectively in the horizontal negative direction, the direction in an angle of −60° with respect to the horizontal direction and a direction in an angle of 60° with respect to the horizontal direction.

The cross section of the second dielectric column is regular triangular; and the material of the second dielectric column is a dielectric with the refractive index greater than 2.

The second dielectric column is made of a silicon material, gallium arsenide, titanium dioxide, or gallium nitride.

The three magneto-optical material columns are ferrite materials, and the cross section of each magneto-optical material column is circular.

The PhC circulator according to the present invention is widely applicable to any electromagnetic wave band such as a microwave band, a millimeter wave band, a terahertz wave band, an infrared wave band or a visible light wave band. Compared with the prior art, the present PhC circulator has the positive effects below.

1. The unidirectional circulation function of a signal among transmission ports in an optical device is realized by utilizing the nonreciprocal characteristic of the magneto-optical materials, which effectively prevents backward transmission of signals, eliminates signal crosstalk and ensures normal operation of optical-circuit systems, and it is a necessary optimized functional device in optical integrated circuits.

2. The guiding triangular column is introduced so as to effectively couple a plurality of magneto-optical material columns together, so that the broadband three-port PhC magneto-optical circulator with excellent performance is obtained for unidirectional optical circular transmission of the signal among the three ports in the device.

3. The broadband three-port optical circulator has the characteristics of high isolation, low insertion loss and wide operating band, thereby sufficiently satisfying the demand of the circulator with excellent functions for optimizing PhC logic optical integrated circuits.

4. The PhC magneto-optical circulator with an air-substrate dielectric-column structure is designed which has a simple form and compact structure, and it is convenient for preparation and can effectively match and be integrated with PhC devices widely used at present.

### DESCRIPTION OF THE DRAWINGS

The present invention is further illustrated below in combination with the drawings and specific embodiments.

FIG. 1 is the structural schematic diagram of the broadband three-port optical circulator with the introduced guiding triangular column according to the present invention.

In FIG. 1: 01-air background 02-first dielectric column; 03-second dielectric column; A, B, C-magneto-optical material columns; 11-first port; 12-second port; 13-third part; w-width of the branched waveguide.

FIG. 2 is the calculated exemplary diagram of the broadband three-port optical circulator with the introduced guiding triangular column according to the present invention.

FIG. 3 is the schematic diagram of first-case light transmission in the broadband three-port optical circulator with the introduced guiding triangular column according to the present invention.

FIG. 4 is the schematic diagram of second-case light transmission of the broadband three-port PhC circulator with the introduced triangular guide column according to the present invention.

FIG. 5 is the schematic diagram of third-case light transmission of the broadband three-port optical circulator with the introduced guiding triangular column according to the present invention.

### DETAILED DESCRIPTION OF PREFERRED EMBODIMENTS

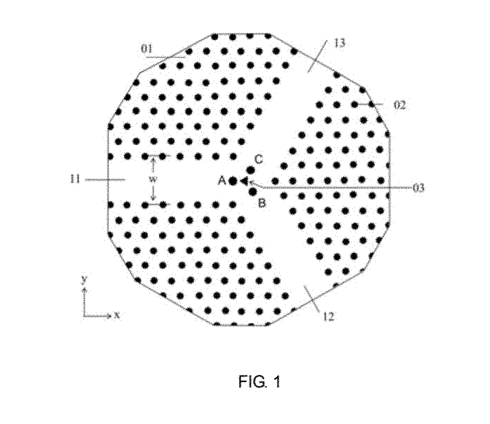

As shown in FIG. 1, said broad-band three-port optical circulator with an introduced guiding triangular column according to the present invention includes a background dielectric with low refractive index, wherein the background dielectric with low refractive index is an air background 01, a PhC of an array of the first dielectric columns in the air background 01 is a two-dimensional triangular-lattice PhC, each first dielectric column 02 is set at one lattice point in the triangular lattice, and the lattice constant a of the PhC is selected as 10.0 mm. The main body of said circulator is a two-dimensional Y-shaped PhC waveguide in the background dielectric with low refractive index, and the Y-shaped PhC waveguide is formed by two-dimensional first dielectric columns 02 arranged by the triangular lattice. The cross section of each first dielectric column 02 is a circle, the radius r1 of the circle is 2.0 mm, the first dielectric column is adopted as a silicon material, and the refractive index is 3.4. In the PhC, a plurality of first dielectric columns 02 are removed respectively along a horizontal negative direction, a direction in an angle of −60° with respect to the horizontal direction and a direction in an angle of 60° with respect to the horizontal direction, and then the PhC at the outer side region between 60° and 180° is integrally translated outwards for a distance b along an axis of 120°, the PhC at the outer side region between 180° and 300° is integrally translated outwards for a distance b along an axis of 240°, and the PhC at the outer side region between −60° and 60° is integrally translated rightwards for a distance b (wherein b=\sqrt{3}a/3, and a is the lattice constant of the PhC) along an axis of 0°, to form the three branches of the PhC waveguide with a width w of(\sqrt{3}+1)a which are intersected and rotationally symmetrically distributed at an angle of 120°. The length of each of the three branches in the PhC waveguide is na, where n is an integer greater than or equal to 4. The three branches of the PhC waveguide are distributed in a “Y” shape to form a Y-shaped PhC waveguide.

The second dielectric column 03 (i.e. a guiding column in the PhC) is introduced at the central position of the PhC, i.e. the intersection point of the three branches of the PhC waveguide, and connection lines between the center of said second dielectric column and the centers of said three ports are respectively in a horizontal negative direction, a direction in an angle of −60° with respect to the horizontal direction, and a direction in an angle of 60° with respect to the horizontal direction; and the cross section of the second dielectric column 03 is a regular triangle, the second dielectric column is adopted as a silicon material, and the refractive index is 3.4. Three identical magneto-optical material columns A, B and C are introduced around the second dielectric column 03 respectively along the horizontal negative direction, a direction in an angle of −60° with respect to the horizontal direction, and a direction in an angle of 60° with respect to the horizontal direction; and the three magneto-optical material columns A, B and C are rotationally symmetrically distributed around the intersection center of the three branches of said PhC waveguide at an angle of 120°, and each magneto-optical material column is placed on the central axis of each branch in said PhC waveguide. The cross sections of the magneto-optical material columns A, B and C are all circle, and the distance from each circle to the center of the second dielectric column 03 is 0.65a, i.e. 6.5 mm. The magneto-optical material columns A, B and C are all adopted as ferrite material with a dielectric constant of 12.9, and a magnetic conductivity tensor as:

$$[ μ ] = {μ}_{0} [ \begin{matrix}{μ}_{r} & j κ & 0 \\ - j κ & {μ}_{r} & 0 \\ 0 & 0 & 1\end{matrix} ] ,$$

wherein κ=ωₘω/(ω₀²−ω²), μᵣ=1+κω₀/ω, ω₀=μ₀γH₀, ωₘ=μ₀γM, γ=1.759×10¹¹ C/kg, M, =2.39×10⁵ A/m. A magnetic field applied to the magneto-optical material columns A, B and C is:

H₀=3.45×10⁵ A/m.

The Y-shaped PhC circulator includes three ports, i.e. a first port 11, a second port 12 and a third port 13, wherein the three ports respectively correspond to the three branches in the PhC waveguide, and the three ports are respectively distributed at the peripheral end surface of the PhC.

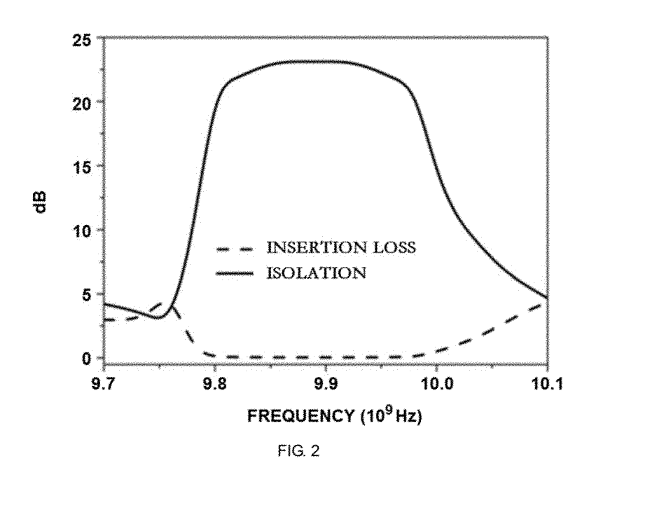

Further. the structural parameters of the Y-shaped optical circulator are optimized: the electromagnetic wave signal is incident from the first port 11, line detectors are respectively arranged at the second port 12 and the third port 13 to obtain powers of the electromagnetic wave signal at the corresponding ports, the insertion loss of the second port 12 is 10log(Pinput/Poutput), the isolation of the third port 13 is 10log(Pinput/Pisolation). wherein. Pinput. Poutput and Pisolation are respectively the signal power detected at the input port (i.e. the first port 11), the signal power detected at the output port (i.e. the second port 12) and the signal power detected at the isolation port (i.e. the third port 13). Calculated curves (as shown in. FIG. 2) of the insertion loss and isolation of the three-port optical circulator are obtained by optimizing the side length of the regular triangle of the second dielectric columns 03 and the cylindrical radius of the magneto-optical material columns A, B and C. In FIG. 2, the dotted line and the solid line respectively indicate the insertion loss of the second port 12 and the isolation of the third port 13 calculated under different frequencies, i.e. the dotted line corresponds to the insertion loss of the circulator, and the solid line corresponds to the isolation of the circulator.

FIG. 2 shows that the optical circulator has a relatively wide operating band which is 9.8 GHz to 10.0 GHz; and in the frequency hand, the insertion loss of the second port 12 is as low as 0.0354 dB, and the isolation of the third port 13 is as high as 23.1 dB. The side length of the regular triangle of the second dielectric columns 03 is optimized to 2.7 mm, and the cylindrical radius of the magneto-optical material columns A, B and C is optimized to 2.7 mm.

Due to the rotational symmetry of the structure, the above-mentioned structural parameter optimization is also applicable to the situation where the electromagnetic wave signal is incident from the second port 12 or the third port 13, and the calculated curves of insertion loss and isolation of the circulator are the same as that shown in FIG. 2.

The operating performance of the three-port optical circulator is tested according to the above optimization results:

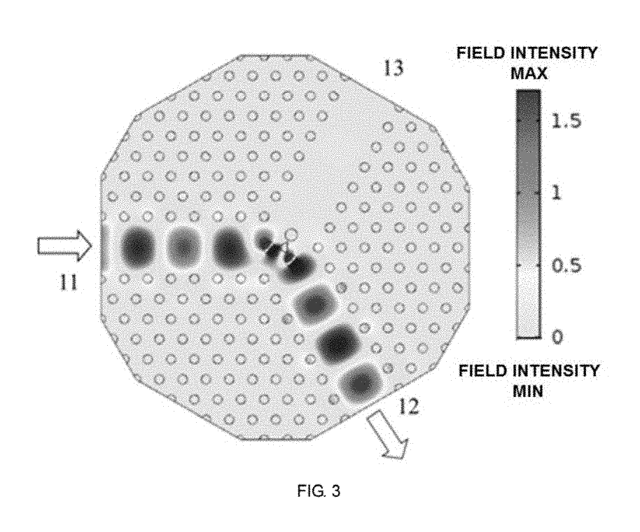

In FIG. 3, an electromagnetic wave of any frequency in the frequency band of 9.8 GHz to 10.0 GHz, for example the electromagnetic wave with the frequency of 9.95 GHz, is selected to be incident from the first port 11, the electromagnetic wave is respectively and sequentially rotated for 60° by the magneto-optical material columns A and B. finally the electromagnetic wave is output from the second port 12, and the insertion loss of the second port 12 is 0.0354 dB. The second dielectric column 03 in the PhC makes the magneto-optical material columns A and B coupling effectively. The third port 13 is in an optically isolated state, wherein the magneto-optical material column C plays a role in isolating the signal of the third port 13, and the isolation of the third port 13 is 23.1 dB,

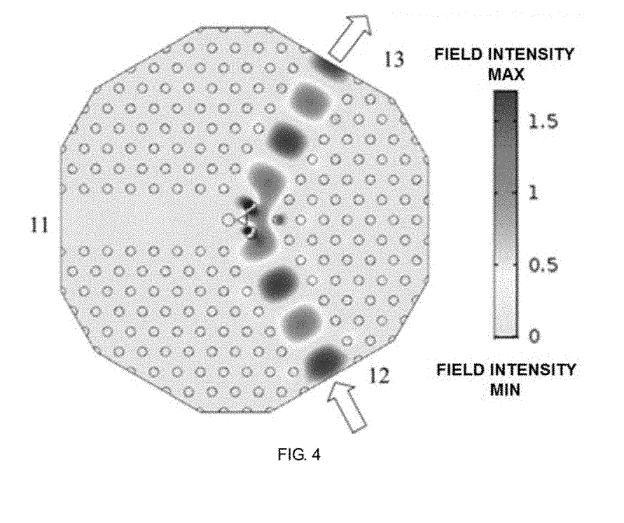

In FIG. 4, the electromagnetic wave with the frequency of 9.95 GHz is selected to be incident from the second port 12, the electromagnetic wave is respectively and sequentially rotated for 60° by the magneto-optical material columns B and C, finally the electromagnetic wave is output from the third port 13, and the insertion loss of the third port 13 is 0.0354 dB. The second dielectric column 03 in the PhC makes the magneto-optical material columns B and C coupling effectively. The first port 11 is in an optically isolated state, wherein the magneto-optical material column A plays a role in isolating the signal of the first port 11, and the isolation of the first port 11 is 23.1 dB.

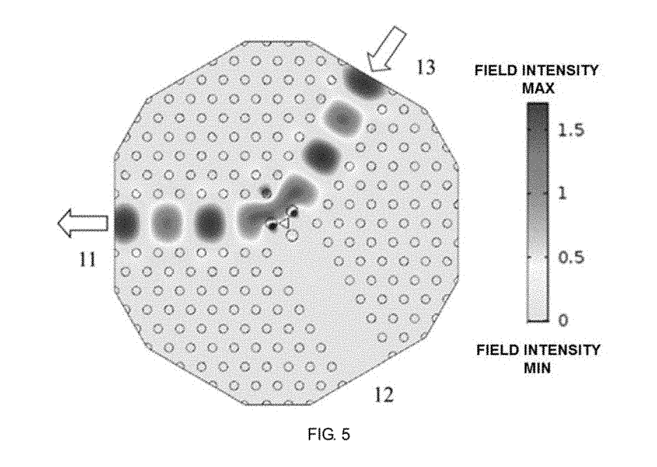

In FIG. 5, the electromagnetic wave with the frequency of 9.95 GHz is selected to be incident from the third port 13, the electromagnetic wave is respectively and sequentially rotated for 60° by the magneto-optical material columns C and A, finally the electromagnetic wave is output from the first port 11, and the insertion loss of the first port 11 is 0.0354 dB. The second dielectric column 03 in the PhC makes the magneto-optical material columns C and A coupling effectively. The second port 12 is in an optically isolated state, wherein the magneto-optical material column B plays a role in isolating the signal of the second port 12, and the isolation of the second port 12 is 23.1 dB.

The optical circulator can realize unidirectional optical circular transmission among the three ports, i.e. the electromagnetic wave signal input from any one of the three ports is output from a next port adjacent thereto according to a same rotational direction, and the other port is the port for isolating the electromagnetic wave signal.

The three-port optical circulator according to the present invention is not limited to the embodiments described above. For example, those skilled in the art can select corresponding materials according to the technical solution revealed by the present invention and according to the scaling principle to the PhC, i.e. the relationship between the operating wavelength of the circulator and the parameters such as the lattice constant of the PhC, the sizes of the first dielectric column and the second dielectric column in the PhC, and the size of the magneto-optical material columns is in a proportional relationship.

The above description is only preferred embodiments of the present invention and is not used for limiting the present invention. Any modification, equivalent replacement, improvement and the like made within the spirit and the principle of the present invention shall be included in the protection scope of the present invention.

We claim:

1. A broadband three-port optical circulator with an introduced guiding triangular column, comprising a photonic crystal formed by an array of a first dielectric column in a background dielectric with low refractive index, wherein said photonic crystal is a two-dimensional triangular-lattice photonic crystal, and each first dielectric column is set at one lattice point in the triangular lattice; said broadband three-port optical circulator further includes three-branch photonic crystal waveguide which has three ports at the outer ends of the three branches, and the three ports are respectively distributed on the peripheral end surface of the photonic crystal; a second dielectric column is arranged at the intersection center of the three branches of said PhC waveguide; three identical magneto-optical material columns A, B and C are respectively arranged at the periphery of the second dielectric column, said A, B and C are rotationally symmetrically distributed around the intersection center of the three branches of said photonic crystal waveguide at an angle of 120°, and each magneto-optical material column is placed on the central axis of the corresponding waveguide branch; an electromagnetic wave signal is input from any one of said three ports and output from a next port adjacent thereto, and the other port is in an isolated state so as to perform the unidirectional optical circular transmission; and the main body of said circulator is a two-dimensional Y-shaped photonic crystal waveguide in the background dielectric with low refractive index, and the Y-shaped photonic crystal waveguide is formed in the two-dimensional triangular-lattice photonic crystal formed by an array of said first dielectric column.

2. The broadband three-port optical circulator with the introduced triangular-guide column according to claim 1, wherein the background dielectric with low refractive index is a dielectric with refractive index less than 1.5.

3. The broadband three-port optical circulator with the introduced triangular-guide column according to claim 1, wherein the background dielectric with low refractive index is air, vacuum, silicon dioxide, or magnesium fluoride.

4. The broadband three-port optical circulator with the introduced triangular-guide column according to claim 1, wherein said first dielectric column is a dielectric with refractive index greater than 2.

5. The broadband three-port optical circulator with the introduced triangular-guide column according to claim 1, wherein said first dielectric column is silicon, gallium arsenide, titanium dioxide, or gallium nitride.

6. The broadband three-port optical circulator with the introduced triangular-guide column according to claim 1, wherein the cross section of said first dielectric column is regular polygonal.

7. The broadband three-port optical circulator with the introduced triangular-guide column according to claim 1, wherein the cross section of said first dielectric column is regular triangular.

8. The broadband three-port optical circulator with the introduced triangular-guide column according to claim 1, wherein the cross section of said first dielectric column is circular.

9. The broadband three-port optical circulator with the introduced triangular-guide column according to claim 1, wherein said three-branch photonic crystal waveguide is Y-shaped photonic crystal waveguide.

10. The broadband three-port optical circulator with the introduced guiding triangular column according to claim 1, wherein said three-branch photonic crystal waveguide is formed by removing a group of first dielectric columns in said photonic crystal respectively along a horizontal negative direction, a direction in an angle of −60° with respect to the horizontal direction and a direction in an angle of 60° with respect to the horizontal direction; the photonic crystal at the region between 60° and 180° is integrally translated outwards for a distance b along the 120° axis, the photonic crystal disposed at the region between 180° and 300° is integrally translated outwards for a distance b along the 240° axis, and the photonic crystal at the region between −60° and 60° is integrally translated rightwards for a distance b along the 0° axis; the three branches of said photonic crystal waveguide are intersected and rotationally symmetrically distributed at an angle of 120°, and b=\sqrt{3}a/3.

11. The broadband three-port optical circulator with the introduced triangular-guide column according to claim 1, wherein the length of the three-branch photonic crystal waveguide is na. the width is (\sqrt{3}+1)α, a is the lattice constant of the photonic crystal, and n is an integer not smaller than 4.

12. The broadband three-port optical circulator with the introduced triangular-guide column according to claim 1, wherein the second dielectric column is a guiding column in said photonic crystal waveguide, and the connection lines between the center of said second dielectric column and the centers of said three ports are respectively in the horizontal negative direction, the direction in an angle of −60° with respect to the horizontal direction and a direction in an angle of 60° with respect to the horizontal direction.

13. The broadband three-port optical circulator with the introduced triangular-guide column according to claim 1, wherein the cross section of the second dielectric column is regular triangular; the second dielectric column is made of a dielectric with refractive index greater than 2.

14. The broadband three-port optical circulator with the introduced triangular-guide column according to claim 1, wherein the second dielectric column is made of a silicon material, gallium arsenide, titanium dioxide, or gallium nitride.

15. The broadband three-port optical circulator with the introduced guiding triangular column according to claim 1, characterized in that the three magneto-optical material columns are made of ferrite materials, and the cross section of each magneto-optical material column is circular.
